(19) United States
(12) Patent Application Publication
(10) Pub. No.: US 2014/0156785 A1
(43) Pub. Date: Jun. 5, 2014

(54) Method and Apparatus for Generating User Notifications

(71) Applicant: BANK OF AMERICA CORPORATION, Charlotte, NC (US)

(72) Inventors: Venkat Kammula, Charlotte, NC (US); John Zemaitis, Charlotte, NC (US)

(73) Assignee: Bank of America Corporation, Charlotte, NC (US)

(21) Appl. No.: 13/693,087

(22) Filed: Dec. 4, 2012

(51) Int. Cl. H04L 29/08

(52) U.S. Cl. CPC H04L 67/26
USPC 709/217

(57) ABSTRACT

Generating user notifications comprises generating a notification-preference file associated with a user account. User preferences associated with a user are stored in the notification-preference file. The notification-preference file is sent to a data module. A notification request according to the user preferences in the notification-preference file is received from the data module. A notification message is generated in a plurality of media types according to the user preferences in the notification-preference file. The notification message is communicated to the user using the plurality of media types indicated in the user preferences.

### TECHNICAL FIELD OF THE INVENTION

The present disclosure relates to communication systems generally, and more particularly to generating user notifications.

### BACKGROUND OF THE INVENTION

Organizations may deliver notifications to its users. Users use a variety of different media types. However, organizations use separate notification modules to distribute notifications for each media type.

### SUMMARY OF THE DISCLOSURE

According to embodiments of the present disclosure, disadvantages and problems associated with generating user notifications may be reduced or eliminated.

Generating user notifications comprises generating a notification-preference file associated with a user account. User preferences associated with a user are stored in the notification-preference file. The notification-preference file is sent to a data module. A notification request according to the user preferences in the notification-preference file is received from the data module. A notification message is generated in a plurality of media types according to the user preferences in the notification-preference file. The notification message is communicated to the user using the plurality of media types indicated in the user preferences.

Certain embodiments of the present disclosure may provide one or more technical advantages. A technical advantage of one embodiment includes providing a system that facilitates the generation of user notifications using various media types for organizations. Having the ability to use a single notification module to receive a notification request and transmit a notification message to user devices using various media types improves the efficiency of the organization. Furthermore, computer resources may be conserved. A technical advantage of one embodiment includes receiving a single notification request and generating a notification message that is communicated to the user using the various media types selected by the user. Having the ability to receive a single notification request and generate a notification message that is communicated over various media types conserves computer resources. Another technical advantage of one embodiment is the simultaneous delivery of notification messages using various media types. Having the ability to simultaneously receive notification messages across various media types increases the probability that a user will promptly receive the notification message.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

For a more complete understanding of the present disclosure and its advantages, reference is made to the following descriptions, taken in conjunction with the accompanying drawings in which:

FIG. 1 illustrates a block diagram of an embodiment of a system for generating user notifications;

FIG. 2 illustrates an example diagram of a notification module; and

FIG. 3 illustrates a flowchart for generating user notifications.

### DETAILED DESCRIPTION

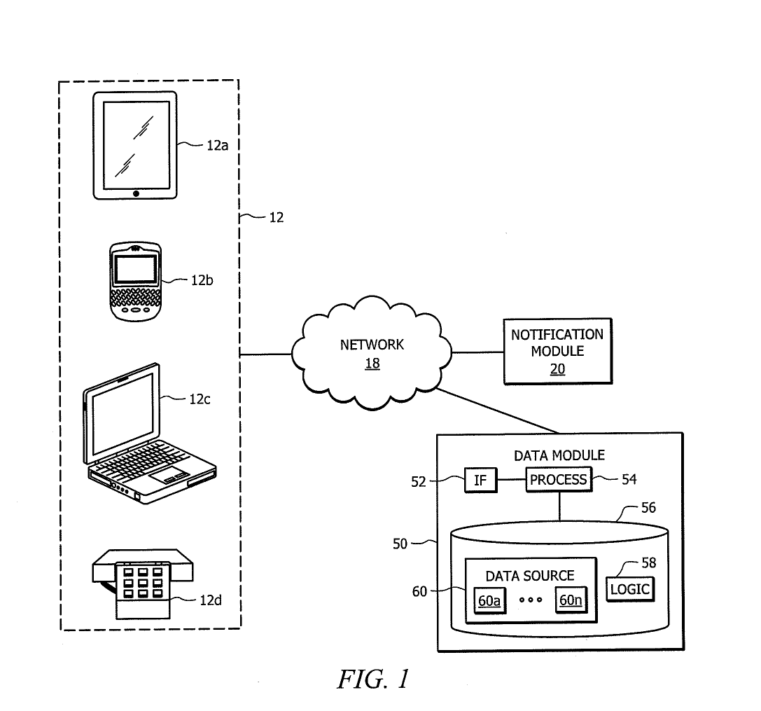

Embodiments of the present disclosure and their advantages are best understood by referring to FIGS. 1 through 3 of the drawings, like numerals being used for like and corresponding parts of the various drawings.

Organizations may communicate notifications to its users. Users use a variety of different media types. However, organizations use separate notification modules to communicate notifications for each media type. For example, an organization may send notification messages to users using electronic mail, short messaging service, and push notification. Currently, the organization would need a separate notification module for electronic mail, a separate notification module for short messaging service, and a separate notification module for push notification. Therefore, a system and method is needed to communicate a notification message across a variety of media types using a single notification module.

FIG. 1 illustrates a block diagram of an embodiment of system 10 for generating user notifications. System 10 includes user devices 12 that communicate over network 18 with notification module 20 to facilitate distribution of notifications. System 10 also includes data module 50 that communicates over network 18 with notification module 20 to facilitate the generation of notification messages.

Using the user devices 12, user preferences may be communicated over network 18 to notification module 20. Notification module 20 may generate a notification-preference file to store the user preferences, which is transferred to data module 50. Once a transaction associated with the user preferences occurs, data module 50 transmits a notification request to notification module 20. Notification module 20 generates a notification message in a plurality of media types according to the user preferences in the notification-preference file. Notification module 20 communicates the notification message to user devices 12 using the plurality of media types indicated in the user preferences. Having used a single notification module 20 to transmit a notification to user devices 12 using a plurality of media types, the efficiency of the organization is improved. Furthermore, computer resources may be conserved.

System 10 includes user devices 12 for inputting user preferences and communicating with notification module 20 over network 18. For example, user preferences may be input into user devices 12 and user devices 12 may communicate the user preferences to notification module 20 over network 18. As another example, user devices 12 may receive a notification message from notification module 20 over network 18. User devices 12 may be a tablet 12a, a smartphone 12b, a personal computer 12c, a telephone 12d or any other device (wireless, wireline, or otherwise) capable of receiving, processing, storing, and/or communicating information with other components of the system. User devices 12 may also include a user interface, such as a display, a touchscreen, a microphone, a keypad, or other appropriate terminal equipment useable by user.

Network 18 represents any suitable network operable to facilitate communication between the components of system 10 such as user devices 12, notification module 20, and data module 50. Network 18 may include any interconnecting system capable of transmitting audio, video, signals, data, messages, or any combination of the preceding. Network 18 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Notification module 20 represents any suitable component that facilitates the generation and storage of a notification-preference file, the reception of a notification request from data module 50, and the generation and communication of a notification message using a plurality of media types. Notification module 20 may include a network server, any suitable remote server, a mainframe, a host computer, a workstation, a web server, a personal computer, a file server, or any other suitable device operable to communicate with user devices 12 and data module 50. In some embodiments, notification module 20 may execute any suitable operating system such as IBM's zSeries/Operating System (z/OS), MS-DOS, PC-DOS, MAC-OS, WINDOWS, UNIX, OpenVMS, or any other appropriate operating system, including future operating systems. The functions of notification module 20 may be performed by any suitable combination of one or more servers or other components at one or more locations. In the embodiment where notification module 20 is a server, the server may be a private server, or the server may be a virtual or physical server. The server may include one or more servers at the same or remote locations. Also, notification module 20 may include any suitable component that functions as a server.

System 10 includes data module 50 for storing information and sending notification requests to notification module 20. In an embodiment, data module 50 stores data in data sources 60, receives a notification-preference file 28 from notification module 20, generates a notification request, and sends the notification request to notification module 20.

Data module 50 may include a network server, any suitable remote server, a mainframe, a host computer, a workstation, a web server, a personal computer, a file server, or any other suitable device operable to communicate with user devices 12 and notification module 20. In some embodiments, data module 50 may execute any suitable operating system such as IBM's zSeries/Operating System (z/OS), MS-DOS, PC-DOS, MAC-OS, WINDOWS, UNIX, OpenVMS, or any other appropriate operating system, including future operating systems. The functions of data module 50 may be performed by any suitable combination of one or more servers or other components at one or more locations. In the embodiment where data module 50 is a server, the server may be a private server, or the server may be a virtual or physical server. The server may include one or more servers at the same or remote locations. Also, data module 50 may include any suitable component that functions as a server. In the illustrated embodiment, data module 50 includes network interface 52, processor 54, and memory 56.

Network interface 52 represents any suitable device operable to receive information from network 18, transmit information through network 18, perform processing of information, communicate with other devices, or any combination of the preceding. For example, network interface 52 receives a notification-preference file 28 from notification module 20. As yet another example, network interface 52 may communicate a notification request to notification module 20. Network interface 52 represents any port or connection, real or virtual, including any suitable hardware and/or software, including protocol conversion and data processing capabilities, to communicate through a LAN, WAN, MAN, or other communication system that allows data module 50 to exchange information with network 18, notification module 20, or user devices 12.

Processor 54 communicatively couples to network interface 52 and memory 56, and controls the operation and administration of data module 50 by processing information received from network interface 52 and memory 56. Processor 54 includes any hardware and/or software that operates to control and process information. For example, processor 54 executes logic 58 to control the operation of data module 50. Processor 54 may be a programmable logic device, a microcontroller, a microprocessor, any suitable processing device, or any suitable combination of the preceding.

Memory 56 stores, either permanently or temporarily, data, operational software, or other information for processor 54. Memory 56 includes any one or a combination of volatile or non-volatile local or remote devices suitable for storing information. For example, memory 56 may include RAM, ROM, magnetic storage devices, optical storage devices, or any other suitable information storage device or a combination of these devices. While illustrated as including particular modules, memory 56 may include any suitable information for use in the operation of data module 50. In the illustrated embodiment, memory 56 includes logic 58 for determining whether a notification request needs to be sent to notification module 20 and data sources 60 for storing information.

Logic 58 generally refers to logic, rules, algorithms, code, tables, and/or other suitable instructions embodied in a computer-readable storage medium for performing the described functions and operations of data module 50. For example, logic 58 facilitates the analysis of notification-preference file 28 sent from notification module 20 to determine whether a particular user is enrolled in a particular notification. If the analysis indicates the user is enrolled in the notification, logic 58 facilitates the analysis of data sources 60 to determine whether a notification request should be generated as described below. Logic 58 may then generate the notification request and the notification request is communicated over network 18 to notification module 20 using network interface 52.

In an embodiment, memory 56 includes data sources 60 for storing information. In general, data sources 60 may be any collection of structured and/or unstructured data. For example, data sources 60 may be a text file, a webpage, a database, a spreadsheet, a document, an inventory flat file, a data warehouse, a machine configuration file, or any other suitable source of information. As an example, data sources 60 may include information relating to mortgage payments, bill payments, online deposits, minimum balance thresholds, interest rates, debits outside the country, and credit card charges.

Data module 50 may use the information stored in data sources 60 to generate a notification request that is sent to notification module 20 if notification-preference file 28 indicates that a user is enrolled in the notification corresponding to information in data sources 60. In an embodiment, data module 50 may send a single notification request to notification module 20 indicating that notification module 20 should generate a notification message to the user and notification module 20 will generate notification messages that are communicated to the user using the various media types indicated in the user's notification-preference file 28. For example, data sources 60 may store information concerning mortgage payments and data module 50 may receive a notification-preference file 28 indicating that a user has enrolled in mortgage-payment notifications. Data module 50 may then send a notification request to notification module 20 when the user makes a mortgage payment and notification module 20 generates mortgage payment notifications that are communicated to the user using the various media types indicated in the user's notification-preference file 28. In another embodiment, data module 50 may generate a batch notification request for a single user that may be enrolled in various notifications. For example, a user may enroll in a daily balance notification, a daily transaction notification, and a daily interest rate notification. Data module 50 may receive a notification-preference file 28 indicating that the user is enrolled in three notifications. Data module 50 may then generate a single batch notification request for the single user that contains a notification request for each notification the user is enrolled in. Notification module 20 may then receive the batch notification request and generate multiple notification messages for all of the notifications the user may be enrolled in. Notification module 20 may then communicate the various notification messages using the various media types indicated in the user's notification-preference file 28. In an embodiment, data module 50 may generate a notification request in real time. For example, if a user enrolled in fraud alerts and a fraudulent transaction occurs, data module 50 may trigger a notification request in real time using Web Services. In that example, data module 50 may immediately send a notification request to notification module 20 and notification module 20 may immediately generate a notification message. In another embodiment, data module 50 may generate a single notification request that contains a request that notification module 20 generate notification messages to more than one user. For example, many users may enroll in nightly balance updates. Data module 50 may generate a batch notification request containing a notification request for each user enrolled in the nightly balance update. Data module 50 may then send the batch notification request to notification module 20 and notification module 20 may then generate and communicate the notification message to each user using each user's selected media types. Although system 10 illustrates data module 50, it should be understood that system 10 may include any number and combination of data modules 50. Data module 50 may be located in any suitable location that is accessible via network 18.

In an exemplary embodiment of operation of system 10, notification module 20 receives user preferences from a user using user devices 12. Notification module 20 generates notification-preference file 28 that includes the user preferences. The user preferences may indicate what types of notifications the user wishes to enroll in and what types of media the user wishes to receive the notifications on. Notification module 20 stores notification-preference file 28 and sends notification-preference file 28 to data module 50. Data module 50 receives notification-preference file 28 and analyzes the file to determine whether a user is enrolled in a particular notification. Data module 50 then analyzes data sources 60 to determine whether information in data sources 60 meets criteria in the notification-preference file 28. If data module 50 determines that the information in data sources 60 meets criteria in the notification-preference file 28, then data module 50 generates a notification request and communicates the notification request to notification module 20.

Notification module 20 receives the notification request and analyzes the notification-preference file 28 to determine the types of media the user wishes to receive the notification message on. Notification module 20 generates the notification message on all of the media types indicated in the notification-preference file 28. Notification module 20 communicates the notification message to the user. In an embodiment, notification module 20 communicates the notification message to the user using the plurality of media types indicated in the notification-preference file 28 simultaneously.

A component of system 10 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

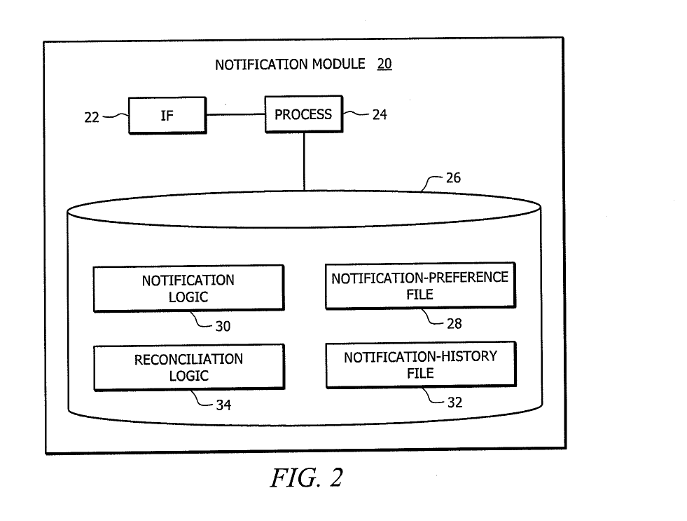

FIG. 2 illustrates an example diagram of notification module 20. In an embodiment, notification module 20 generates notification-preference file 28, stores user preferences in notification-preference file 28, sends notification-preference file 28 to data module 50, receives a notification request from data module 50, generates a notification message in a plurality of media types according to the user preferences in notification-preference file 28, communicates the notification message to the user using the plurality of media types, determines whether the notification message was successfully received, updates and stores the notification history in notification-history file 32, and communicates a failure response to the user if the notification message was not successfully received. In the illustrated embodiment, notification module 20 includes network interface 22, processor 24, and memory 26.

Network interface 22 represents any suitable device operable to receive information from network 18, transmit information through network 18, perform processing of information, communicate with other devices, or any combination of the preceding. For example, network interface 22 may receive user preferences from user devices 12. As another example, network interface 22 may communicate a notification-preference file 28 to data module 50. As yet another example, network interface 22 may receive a notification request from data module 50. As yet another example, network interface 22 may communicate a notification message to user devices 12 using the plurality of media types. Network interface 22 represents any port or connection, real or virtual, including any suitable hardware and/or software, including protocol conversion and data processing capabilities, to communicate through a LAN, WAN, MAN, or other communication system that allows notification module 20 to exchange information with network 18, data module 50, or user devices 12.

Processor 24 communicatively couples to network interface 22 and memory 26, and controls the operation and administration of notification module 20 by processing information received from network interface 22 and memory 26. Processor 24 includes any hardware and/or software that operates to control and process information. For example, processor 24 may execute notification logic 30 and/or reconciliation logic 34 to control the operation of notification module 20. Processor 24 may be a programmable logic device, a microcontroller, a microprocessor, any suitable processing device, or any suitable combination of the preceding.

Memory 26 stores, either permanently or temporarily, data, operational software, or other information for processor 24. Memory 26 includes any one or a combination of volatile or non-volatile local or remote devices suitable for storing information. For example, memory 26 may include RAM, ROM, magnetic storage devices, optical storage devices, or any other suitable information storage device or a combination of these devices. In the illustrated embodiment, memory 26 includes notification-preference file 28 for storing user preferences, notification logic 30 for generating user notifications, notification-history file 32 for storing a user's notification history or notification status, and reconciliation logic 34 for ensuring end-to-end reconciliation of notification messages.

Notification-preference file 28 may be a text file, a webpage, a database, a spreadsheet, a document, an inventory flat file, a data warehouse, a machine configuration file, or any other suitable source of information. In an embodiment, notification module 20 receives user preferences from user devices 12. Notification-preference file 28 may include media preferences and notification-type preferences. Media preferences may indicate what types of media the user wishes to receive notification messages by. For example, a user may wish to receive notification messages by at least one of the following media types: Short Message Service (SMS) message, an electronic mail (e-mail), a push notification, a voice message, a social-media message, and a Really Simple Syndication feed (RSS®). A social-media message may include a Facebook® message, a Twitter® message, a MySpace® message, or any other type of social-media message. As an example, a push notification may be received on user devices 12 that use iOS®, Android®, Windows 7®, or Windows 8® operating systems. Notification messages communicated using e-mail may be sent to all e-mail domains. Notification messages communicated using SMS may be sent to users of all carriers. Notification messages communicated using a voice message may be sent to users of all carriers. Notification-type preferences may include the various notifications that a user wishes to receive. For example, a user may wish to receive at least one of the following notifications: a low-balance notification, a deposit notification, a withdrawal notification, a fraud notification, a mortgage-payment notification, a low-interest notification, an offer notification, a coupon notification, or any other notification. It may be appreciated that additional information may be stored in the notification-preference file 28.

In the illustrated embodiment, notification module 20 also includes notification logic 30 for generating notification-preference file 28, sending notification-preference file 28 to data module 50, analyzing the notification request received from data module 50, analyzing notification-preference file 28 to determine the media types the user wishes to receive notification messages on, generating the notification message using the plurality of media types, and communicating the notification message to the user using the plurality of media types indicated in notification-preference file 28. Notification logic 30 generally refers to logic, rules, algorithms, code, tables, and/or other suitable instructions embodied in a computer-readable storage medium for performing the described functions and operations of notification module 20. For example, notification logic 30 may facilitate the generation of notification-preference file 28. As another example, notification logic 30 may facilitate the transmission of notification-preference file 28 to data module 50. As yet another example, notification logic 30 may facilitate the analysis of the notification request received from data module 50. Notification logic 30 may then analyze notification-preference file 28 to determine what types of media the user wishes to receive a notification message by. Notification logic 30 may then generate the notification message using the plurality of media types indicated in the notification-preference file and communicate the notification message over network 18 to user devices 12 using network interface 22. In an embodiment, notification logic 30 may generate and communicate the notification message simultaneously using the plurality of media types.

In the illustrated embodiment, memory 26 includes a notification-history file 32 for storing a user's notification history. Notification-history file 32 may be a text file, a webpage, a database, a spreadsheet, a document, an inventory flat file, a data warehouse, a machine configuration file, or any other suitable source of information. For example, notification module 20 communicates a notification message to user devices 12. If user devices 12 successfully receive the notification message, reconciliation logic 34 may enter a record into notification-history file 32 to indicate that user devices 12 successfully received the notification message. As another example, if user devices 12 failed to receive the notification message, reconciliation logic 34 may enter a record to indicate that user devices 12 failed to receive the notification message. As another example, reconciliation logic 34 may trigger a failure response that is communicated to the user by United States Postal Service. Such a failure response would ensure that the user is alerted to the failure and could update the user's preferences in the notification-preference file 28. It may be appreciated that additional information may be stored in notification-history file 32.

Reconciliation logic 34 may also create automated reports for organizational use by extracting the notification-history file 32. For example, reconciliation logic 34 may create a report that may contain the notification types and the amount of each notification type that was sent in a day. As another example, reconciliation logic 34 may create a failure report that may contain the notification types and the amount of each notification that failed to deliver to the user. As an additional example, reconciliation logic 34 may create a report that may contain the notification types and the amount of each notification that complied or did not comply with Service Level Agreements.

In the illustrated embodiment, notification module 20 also includes reconciliation logic 34 for generating notification-history file 32, updating notification-history file 32, and communicating a failure response to the user upon indication that the notification message was not delivered. Reconciliation logic 34 generally refers to logic, rules, algorithms, code, tables, and/or other suitable instructions embodied in a computer-readable storage medium for performing the described functions and operations of notification module 20. For example, reconciliation logic 34 may facilitate the generation of notification-history file 32. As another example, reconciliation logic 34 may facilitate the update of notification-history file 32 to indicate the status of a notification message. In an embodiment, reconciliation logic 34 may update a record in notification-history file 32 indicating that user devices 12 successfully received a notification message. In another embodiment, reconciliation logic 34 may update a record in notification-history file 32 indicating that user devices 12 failed to successfully receive a notification message and generate a failure response that is communicated to user devices 12. As an example, the failure response may indicate to user devices 12 that notification module 20 has the user's incorrect e-mail address thereby prompting the user to update the user's preferences in notification-preference file 28. In another embodiment, the failure response may include the unsuccessfully delivered notification message. It may be appreciated that the failure response may include additional information. While illustrated as including a particular module, memory 26 may include any suitable information for use in the operation of notification module 20.

In an exemplary embodiment of operation, notification module 20 receives user preferences from user devices 12 through network interface 22. Notification module 20 generates notification-preference file 28 that includes the user preferences. The user preferences may indicate what types of notifications the user wishes to enroll in (notification-type preferences) and what types of media the user wishes to receive the notifications on (media preferences). Notification module 20 stores notification-preference file 28 in memory 26 and sends notification-preference file 28 to data module 50. Notification module 20 may receive a notification request from data module 50 indicating that a notification message should be sent to user devices 12. Notification module 20 receives the notification request and analyzes the notification-preference file 28 to determine the types of media the user wishes to receive the notification message by. Notification module 20 generates the notification message on all of the media types indicated in the notification-preference file 28. Notification module 20 communicates the notification message to user devices 12. In an embodiment, notification module 20 communicates the notification message to user devices 12 using the plurality of media types indicated in the notification-preference file 28 simultaneously. In an embodiment, notification module 20 may be capable of providing 24/7 support for generating notification messages.

Modifications, additions, or omissions may be made to notification module 20 without departing from the scope of the invention. For example, notification module 20 may include any number of notification-preference files 28 or notification-history files 32. Any suitable logic may perform the functions of notification module 20 and the components within notification module 20.

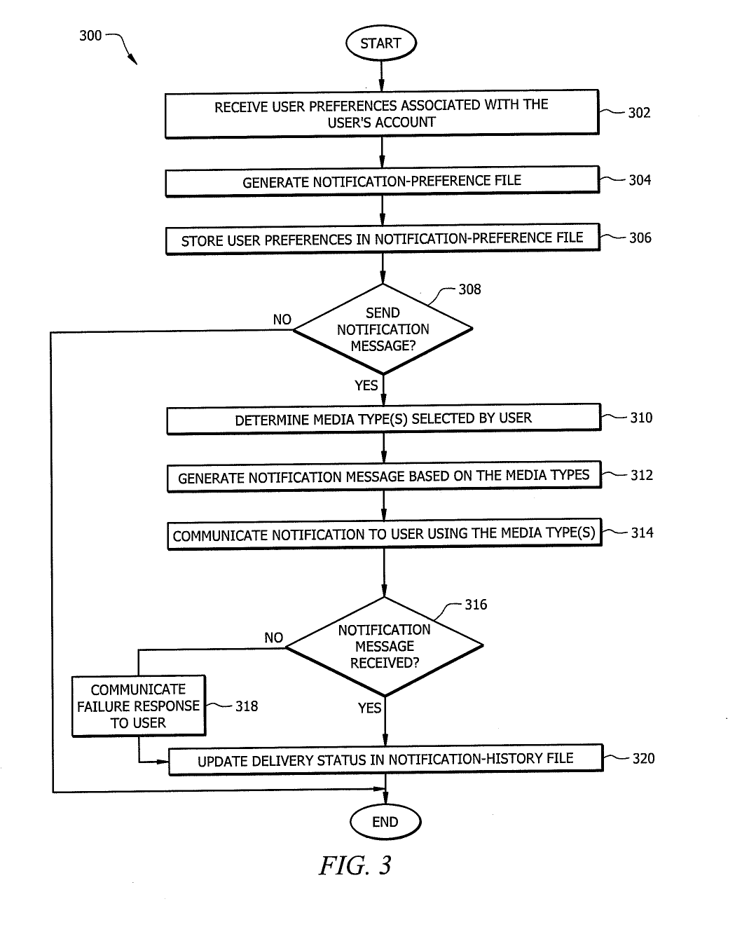

FIG. 3 illustrates a flowchart 300 for generating user notifications. At step 302, notification module 20 receives user preferences associated with a user's account. In general, a user inputs user preferences using user devices 12 and user devices 12 communicate the user preferences to notification module 20 over network 18. The user preferences may include what types of notifications the user wishes to receive (notification-type preferences) and what types of media the user wishes to receive the notifications by (media preferences). For example, a user may use an iPad® to indicate that the user prefers to receive an account balance notification on a nightly basis by an SMS message, a push notification, and an e-mail. Once the user inputs the user preferences using user devices 12 and user devices 12 communicate the user preferences over network 18 to notification module 20, notification module 20 receives the user preferences associated with the user's account.

At step 304, notification module 20 generates notification-preference file 28. Notification-preference file 28 includes user preferences associated with a user account. At step 306, notification module 20 stores notification-preference file 28 in memory 26.

At step 308, notification module 20 determines whether to send a notification message. In an embodiment, notification module 20 sends notification-preference file 28 to data module 50. Data module 50 then determines whether information in data sources 60 meets criteria in notification-preference file 28. For example, the user preferences in notification-preference file 28 may indicate that a user wishes to receive a daily summary of debit transactions. Data module 50 then analyzes data sources 60 to determine whether any debit transactions were made on that particular day. If so, data module 50 sends a notification request to notification module 20 indicating that a debit transaction notification needs to be sent to the user. In an embodiment, data module 50 sends a single notification request to notification module 20 indicating that notification module 20 should generate a notification message and communicate the notification message to the user using the various media types indicated in the user's notification-preference file 28. If data module 50 does not send a notification request to notification module 20, then notification module 20 does not send any notification messages to user devices 12 and the method ends. However, if notification module 20 receives a notification request, then the method proceeds to step 310.

At step 310, notification module 20 determines the media types selected by the user using user devices 12. Notification module 20 determines the media types selected by the user by analyzing notification-preference file 28, which indicates the various media types the user wishes to receive notification messages by. The user may select at least one of the following media types: an e-mail, an SMS message, a push notification, a voice message, a social-media message, and an RSS® feed. It may be appreciated that notification module 20 may support additional media types.

At step 312, notification module 20 generates a notification message based on the various media types indicated in notification-preference file 28. For example, if notification-preference file 28 indicates the user wishes to receive notification messages by an e-mail, an SMS message, and a push notification, notification module 20 takes the notification request received from data module 50 and generates an e-mail notification message, an SMS notification message, and a push notification notification message. As another example, notification module 20 may generate a Facebook® message, a Twitter® message, or a MySpace® message if notification-preference file 28 indicates the user wishes to receive notification messages by social-media messages. As an example, the Facebook® message may be a direct or instant message. As another example, the Facebook® message may be through a Facebook® application. At step 314, notification module communicates the notification message to user devices 12 using the media types indicated by the user in notification-preference file 28.

At step 316, notification module 20 determines the status of notification messages. As an example, notification module 20 may communicate a notification message to user devices 12 and user devices 12 may acknowledge receipt of the notification message with an acknowledgment message. As another example, notification module 20 may communicate a notification message to user devices 12 and wait for an acknowledgment message for a predetermined period of time. After the predetermined period of time passes without notification module 20 receiving an acknowledgment message, notification module 20 may determine that the notification message was not successfully received by user devices 12. As yet another example, notification module 20 may communicate a notification message to user devices 12 and user devices 12 may respond with a negative acknowledgment indicating that the notification message was not successfully received or was received with errors. It may be appreciated that various methods may be used to determine the status of a notification message.

If the notification module 20 determines that a notification message was not successfully received by user devices 12, the method proceeds to step 318. At step 318, notification module 20 communicates a failure response to user devices 12. For example, notification module 20 may communicate a failure response indicating that a notification message was not successfully delivered. As another example, notification module 20 may communicate a failure response indicating that a user's e-mail address is incorrectly listed in notification-preference file 28 thereby prompting the user to update the user's e-mail address. As another example, notification module 20 may communicate a failure response including the original notification message in the failure response. It may be appreciated that a failure response may include additional information.

At step 320, notification module 20 updates the status of a notification message in notification-history file 32. For example, if notification module 20 receives an indication that a notification message was successfully delivered, then notification module 20 may update a record in notification-history file 32 indicating that the notification message was successfully delivered to user devices 12. As another example, if notification module 20 receives an indication that a notification message was not successfully delivered, then notification module 20 may update a record in notification-history file 32 indicating that the notification message was not successfully delivered. As yet another example, if notification module 20 receives an indication that a user's e-mail address is incorrectly listed in notification-preference file 28, then notification module 20 may update a record in notification-history file 32 indicating that an incorrect e-mail address is listed for the user.

Modifications, additions, or omissions may be made to method 300 depicted in FIG. 3. The method may include more, fewer, or other steps. Additionally, steps may be performed in parallel or in any suitable order. While discussed as notification module 20 performing the steps, any suitable component of system 10 may perform one or more steps of the method.

Certain embodiments of the present disclosure may provide one or more technical advantages. A technical advantage of one embodiment includes providing a system that facilitates the generation of user notifications using various media types for organizations. Having the ability to use a single notification module 20 to receive a notification request and transmit a notification message to user devices 12 using various media types improves the efficiency of the organization. Furthermore, computer resources may be conserved. A technical advantage of one embodiment includes receiving a single notification request and generating a notification message that is communicated to the user using the various media types indicated in the notification-preference file 28. Having the ability to receive a single notification request and generate a notification message that is communicated over various media types conserves computer resources. Another technical advantage of one embodiment is the simultaneous delivery of notification messages using various media types. Having the ability to simultaneously receive notification messages across various media types increases the probability that a user will promptly receive the notification message.

Although the present disclosure has been described in several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system for generating notifications, comprising:
a processor operable to generate a notification-preference file associated with a user account;
a memory communicatively coupled to the processor and operable to store user preferences associated with a user in the notification-preference file;
a network interface communicatively coupled to the processor and operable to:
send the notification-preference file to a data module; and
receive a notification request from the data module according to the user preferences in the notification-preference file;
the processor further operable to generate a notification message in a plurality of media types according to the user preferences in the notification-preference file; and
the network interface further operable to communicate the notification message to the user using the plurality of media types indicated in the user preferences.

2. The system of claim 1, wherein the processor is further operable to:
determine whether the user received the notification message; and
update a notification history file to indicate a status of the notification message.

3. The system of claim 1, wherein the processor is further operable to:
determine whether the user received the notification message; and
if the user failed to receive the notification message, communicate a failure response to the user.

4. The system of claim 1, wherein the media types comprise at least one of the following media types: an electronic mail, a short message service, a push notification, a voice message, a social media message, and a real simple syndication feed.

5. The system of claim 1, wherein the processor is further operable to communicate the notification message to the user by simultaneously communicating the notification message using the plurality of media types.

6. The system of claim 1, wherein the processor is further operable to receive a notification request from the data module by receiving a determination whether information in the data module meets criteria in the user preferences.

7. The system of claim 1, wherein the user preferences comprise a selected one of media preferences and notification-type preferences.

8. A method for generating user notifications, comprising:
generating, using a processor, a notification-preference file associated with a user account;
storing user preferences associated with a user in the notification-preference file;
sending the notification-preference file to a data module;
receiving a notification request from the data module according to the user preferences in the notification-preference file;
generating, using the processor, a notification message in a plurality of media types according to the user preferences in the notification-preference file; and
communicating the notification message to the user using the plurality of media types indicated in the user preferences.

9. The method of claim 8, further comprising:
determining whether the user received the notification message; and
updating a notification history file to indicate a status of the notification message.

10. The method of claim 8, further comprising:
determining whether the user received the notification message; and
if the user failed to receive the notification message, communicating a failure response to the user.

11. The method of claim 8, wherein the media types comprise at least one of the following media types: an electronic mail, a short message service, a push notification, a voice message, a social media message, and a real simple syndication feed.

12. The method of claim 8, wherein communicating the notification message to the user comprises simultaneously communicating the notification message using the plurality of media types.

13. The method of claim 8, wherein receiving a notification request from the data module comprises receiving a determination whether information in the data module meets criteria in the user preferences.

14. The method of claim 8, wherein the user preferences comprise a selected one of media preferences and notification-type preferences.

15. Non-transitory computer readable medium comprising logic, the logic, when executed by a processor, operable to:
generate a notification-preference file associated with a user account;
store user preferences associated with a user in the notification-preference file;
send the notification-preference file to a data module;
receive a notification request from the data module according to the user preferences in the notification-preference file;
generate a notification message in a plurality of media types according to the user preferences in the notification-preference file; and
communicate the notification message to the user using the plurality of media types indicated in the user preferences.

16. The computer readable medium of claim 15, wherein the logic is further operable to:
determine whether the user received the notification message; and
update a notification history file to indicate a status of the notification message.

17. The computer readable medium of claim 15, wherein the logic is further operable to:
determine whether the user received the notification message; and
if the user failed to receive the notification message, communicate a failure response to the user.

18. The computer readable medium of claim 15, wherein the media types comprise at least one of the following media types: an electronic mail, a short message service, a push notification, a voice message, a social media message, and a real simple syndication feed.

19. The computer readable medium of claim 15, wherein the logic is further operable to communicate the notification message to the user by simultaneously communicating the notification message using the plurality of media types.

20. The computer readable medium of claim 15, wherein the logic is further operable to receive a notification request from the data module by receiving a determination whether information in the data module meets criteria in the user preferences.

21. The computer readable medium of claim 15, wherein the user preferences comprise a selected one of media preferences and notification-type preferences.
